(19) United States
(12) Patent Application Publication
(10) Pub. No.: US 2026/0178604 A1
(43) Pub. Date: Jun. 25, 2026

(54) AI-Assisted Generation of Spatially Accurate, Multi-Modal Augmented Reality Protocols

(71) Applicant: LabLightAR, Inc., Seattle, WA (US)

(72) Inventors: Roger Brent, Seattle, WA (US); David Dudley Moore, Berkeley, CA (US); J. Anthony Mein, Seattle, WA (US); Nikolas Oak Stires, Rohnert Park, CA (US); Karrington Ogans, Seattle, WA (US)

(21) Appl. No.: 19/426,525

(22) Filed: Dec. 19, 2025

Related U.S. Application Data
(60) Provisional application No. 63/736,414, filed on Dec. 19, 2024.

(51) Int. Cl. G06F 16/25; G06F 16/3329; G06F 40/205; G06F 40/279

(52) U.S. Cl. CPC G06F 16/258; G06F 16/3329; G06F 40/205; G06F 40/279

(57) ABSTRACT

A computer platform to automate the creation of laboratory protocol representations that can be used by an augmented reality platform is disclosed. A laboratory protocol representation captures not only the steps to perform a lab bench workflow, but also includes meta information about the protocol, supplemental information, and information on what virtual objects to render on the augmented reality platform. The platform orchestrates generative artificial intelligence applications to receive user input and external factors to create customized versions of the laboratory protocol and then makes use of generative artificial intelligence applications to validate the generated protocol representations. To mitigate the risk of hallucinations, the platform makes use of iterative hallucination detection methodologies including recursive Chain-of-Thought (rCoT) and Contrastive Verification (CoVe).

### CROSS-REFERENCE TO RELATED APPLICATIONS

This application claims priority to a commonly owned, U.S. Provisional Patent Application No. 63/736,414, filed on Dec. 19, 2024, and titled “AI-Assisted Generation of Spatially Accurate, Multi Modal, Augmented Reality Protocols,” which is herein incorporated by reference in its entirety.

### BACKGROUND OF THE INVENTION

LabLight Augmented Reality, LLC (LLAR) has long been engaged in developing augmented reality (AR) platforms to support laboratory benchwork, in particular for life sciences. Specifically, lab workers perform workflows called protocols, which involve manipulating objects, such as lab equipment, in order to manipulate reagents, such as chemical and biological feedstock, to obtain a desired result. These protocols are comprised of one or more steps in which the objects and reagents are progressively manipulated by the lab workers to achieve the desired result.

Since lab workers are human beings, human error is inevitable. The price of errors is substantial. The cost of an error by a lab worker in making a DNA specific bespoke pill can be in the tens of thousands. Accordingly, there is a need for techniques to reduce or eliminate human errors.

One technique is to make use of AR platforms in which a lab worker may be walked through a protocol step by step. The AR platform can display the specific steps, track the progress of the lab worker, and provide supplemental information. The provision of supplemental information relevant to a particular step and/or scenario is called “situational awareness”. Supplemental information for situational awareness metadata is called “situational awareness indicia.”

Beyond situational awareness, the AR platform can generate virtual objects, and display those virtual objects overlaid on the lab worker's lab bench. This provides spatially accurate visual information to the lab worker to further prevent and eliminate human error. Examples of virtual objects range from indicators showing progress, to errors and warnings, and even overlays over physical objects and reagents to indicate state. In the latter example, the AR platform can have the ability to not only create virtual objects corresponding to physical objects but also do so such that the virtual objects match the attitude, motion, and behavior of the physical object.

The AR platform's ability to follow a laboratory protocol, provide situational awareness, and to generate virtual objects relies on receiving information about that protocol in a standardized format for an augmented reality computer platform that includes the situational awareness and object and reagent information. Hand generation of the protocols in that standardize format is error prone. Even if hand generation was not error prone, the sheer number of protocols available could not be converted by hand in a timely manner. As a data point, the lab handbook, “Current Protocols in Molecular Biology,” describes tens of thousands of protocols. Manual generation is not practical for generating an extensive and comprehensive library of protocols.

Accordingly, there is a need for the automated generation of laboratory protocols in a standardized format for an augmented reality computer platform including, situational awareness and object and reagent information, and verification that the laboratory protocols were generated correctly.

We note that protocols are not “one size fits all” and benefit from end user customization. Accordingly, there is a further need to automate the modification of the laboratory protocols, both from user input and from automation.

### BRIEF DESCRIPTION OF DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a context diagram for Artificial Intelligence (AI) Generation of AR Protocols.

FIG. 2 is a diagram of an exemplary environment for AI Generation of AR Protocols.

FIG. 3 is a block diagram for AI driven AR Protocol Generation platform.

FIG. 4 is a flow chart for AI driven AR Protocol Generation.

FIG. 5 is a flow chart for validation of AI Generated AR Protocols.

### DETAILED DESCRIPTION OF THE INVENTION

### The Motivation for AI Generation of AR Protocols

### Augmented Reality Assisted Lab Bench Work

To better understand AI Generation of AR Protocols, it is worthwhile to discuss the ecosystem for AR Assisted Lab Bench work. From this discussion, the motivations driving AI generation of AR protocols will become apparent.

There has been work with respect to augmented, mixed, and/or extended reality, the group of them collectively referred to as “augmented reality” or more simply, “AR”) as the superimposition, via the user's sensorium, of information constructs (representations of bits or data and also referred to as “virtual objects”) upon a person's perceived physical world. The development of workable “strong” AR devices, such as the first and second generation Microsoft's HoloLens®, the Magic Leap One® and its successor the Magic Leap Two®, and Apple's Vision Pro®, to name just a few, demonstrate that we are entering the era where AR hardware can accomplish the task of superimposing the information constructs onto physical realities.

These latest advancements of AR hardware will likely revolutionize numerous fields of work, including laboratory work that requires people operate/act on physical objects in conjunction with information constructs. Another use-group includes researchers, referred to as “practitioners,” includes those who work in advanced biological manufacturing. More generally, strong and/or robust AR devices will enable the presentation of information constructs in conjunction with physical objects in providing procedural guidance, guidance that will be of particular utility for workers who spend much of their time interacting with the objects in the physical world using their hands.

Many of the most compelling imagined uses of AR, including AR-provided procedural guidance, require particular abilities that current and near future headsets do not have. These include, by way of illustration and not limitation: (a) an ability to identify or support the identification of physical objects; (b) an ability to determine, with high resolution and accuracy, the localization of physical objects in the physical world; (c) an ability to determine, with high spatial resolution and accuracy, the orientation (attitude or pose) of objects in the physical world; and (d) an ability to keep track of physical objects as they move or are moved through the physical world and as they change their pose over time.

Additional AR device abilities may also include, again by way of illustration and not limitation: e) an ability to generate high resolution, accurately and spatially positioned and/or posed virtual objects in the user's sensorium; (f) an ability to adjust the location, pose, and shape of virtual objects over time; (g) an ability of the AR system to “understand” the physical work environment as well as the work task at hand; and (h) features to request, from a practitioner, additional information and guidance at a level appropriate to the practitioner's level of knowledge and skill.

Some of the above functionalities and abilities are needed for various uses. These include the identification and accurate determination of location and attitude of objects in the physical world (for example, the user's hands) in order to direct the localization and orientation of virtual objects reified in the virtual world.

One reason current AR devices cannot support the functions identified above is based on the fact that the ability of AR devices to resolve and localize physical and virtual objects is only accurate within a few centimeters, any approximation identification, tracking and/or determination of pose for physical objects is not supported at all.

The consequence of the current lack of spatial accuracy in AR devices, as well as other shortcomings of current AR devices (including those identified above) is this: current AR devices cannot localize physical and virtual objects (e.g., the size of screws, switches, knobs, and/or fingertips) and, thus, cannot provide guidance for procedures operating on these or other objects of similar scales. These same limitations on spatial localization and precise determination of pose apply to VR devices in those instances where applications in VR need to localize and determine pose of objects in the physical world, and to use that information to generate objects or actions in the virtual world.

Currently, off-device computation supporting object identification, object tracking, and determination of an object's pose is increasingly carried out by deep neural networks trained to recognize individual objects and object classes, rather than using computational analytical geometry or other deterministic machine vision approaches. This approach, off-device computational support, has its disadvantages. In the early 2020s, neural networks were frail, especially when presented with data or information not represented in their training data. Also, due to their inscrutability, it was difficult, to the point of being impossible, to troubleshoot errors made by trained neural networks and correct those errors. These problems have been greatly eased by the advent of foundation AI models, especially Large Language Models (LLMs) and/or Large Multimodal Models (LMMs). These models promise great improvements in computer vision tasks, although they remain inscrutable.

Yet another limitation of current AR devices for implementing spatially accurate procedural guidance is the fact that object identification and tracking are not carried out by the headsets. Indeed, regarding object identification and tracking, AR systems are implemented in such a way that any additional processing needed to carry out these two functions, beyond the features of the AR devices such systems support, will be carried out not locally, but in the cloud. In other words, object identification and tracking need to rely upon the computation of the “cloud”. However, cloud computation introduces latency. It also carries with it security risks: that information and processing carried out in the cloud will be accessible to the cloud service providers, and that this information and processing might be breach of privacy stations, as well as potential breaches by third parties. For that reason, we must continue to allow the use of a local base computation for this processing.

In accordance with aspects of the disclosed subject matter, systems and services are presented that enhanced the abilities of AR devices to carry out the following functions using AR devices and their supporting systems: (a) identify and support the identification of physical objects; (b) provide spatially accurate, high resolution localization of physical; (c) provide spatially accurate, high resolution determination of orientation (attitude or pose) of physical objects; (d) track physical objects as they move or are moved through space and change pose over time; and (e) generate high resolution, accurately spatially positioned and posed virtual objects and adjust their location, pose, and shape over time.

For some of the envisioned uses of AR devices, and especially their supporting systems, there is need to carry out the computations supporting these functions locally, rather than in the cloud.

### AI Generation of Protocols to Provide AR Procedural Guidance

The disclosed and described system embodies the significant progress in providing active procedural guidance for laboratory and/or other complex manual operations. Indeed, shortcomings of prior systems have been addressed by the development of a robust and mature AR device. According to aspects of the disclosed subject matter, we propose the use of Foundation AI models to make interaction protocols more easily, to make the protocols smarter, and the to make operator smarter.

One feature of the disclosed subject matter is the “AR-ization” of protocols that was formerly managed by humans, by extraction of written protocols from either previous protocols or text, then used by an operator of a system to “run” the protocol. However, in accordance with aspects of the disclosed subject matter, a new system uses proprietary AI to turn prose or other protocol information into a standard protocol format. This standard protocol format is then processed into an AR-system executable format. The executable format comprises, at least: (a) modular step definitions with parameterized variables for dynamic adjustment; (b) embedded spatial coordinates and object references; (c) embedded verification checkpoints with pass/fail criteria; (d) metadata including required equipment, reagents, and safety information; and (e) version control and modification tracking elements.

A second feature of the disclosed subject matter addressed prior “AR-ized” protocols which were “one size fits all.” Indeed, prior protocols did not allow facile, let alone automatic, changes in the instructions to reflect slight variations in a procedure. For example, it was nearly impossible to adjust calculated volumes of liquid reagents in response to changes in the numbers of samples to be analyzed. In contrast, the disclosed subject matter includes, without limitation, the use of a proprietary AI system to allow an operator to easily make changes in a given protocol. This protocol modification system specifically enables, by way of illustration and not limitation: (a) parameter-based volume scaling with automatic dependency resolution; (b) step sequence reorganization with constraint preservation; (c) equipment substitution with compatibility verification; (d) temporal adjustment of wait steps with validation; and (e) resource requirement recalculation with availability checking.

A third feature of the disclosed subject matter addresses prior systems resulting in “AR-ized” protocols that are “one size fits all,” but in a different manner than identified above. These prior “AR-ized” protocols did not allow an operator to ask follow-up questions or seek clarificatory information, and they did not tailor their instructions to the knowledge level or skill level of the operator. In accordance with aspects of the disclosed subject matter, the proprietary AI system packages such information in text or protocols in numerous different ways. Many of these different ways are “canned,” and an operator can find ways to work in the protocol that are most comfortable for them. Indeed, during the workflow, the novel proprietary AI systems allow the operator to ask different sets of questions, follow up questions, pursue deeper investigations, and receive text and visual guidance appropriately tailored to the operator's skill and knowledge.

A fourth innovation of the disclosed subject matter addresses failings in, even the complete lack of the implementation of a robust hallucination detection and verification system. According to embodiments of the disclosed subject matter, the disclosed system orchestrates several LLM agents with recursive Chain-of-Thought (rCoT) reasoning and Contrastive Verification (CoVe) techniques to ensure protocol accuracy. By way of illustration and not limitation, the disclosed verification system: (a) extracts verification criteria from generated protocols using multi-step reasoning; (b) compares extracted criteria against original specifications and known constraints; (c) implements automated regeneration loops until verification thresholds are met; and (d) maintains protocol integrity while allowing flexible modifications.

In various embodiments of the disclosed subject matter, the verification system is comprised of the following logical agents and processes: a primary LLM that generates initial protocol conversion (from prior protocols); a secondary LLM acts to critique to validate steps; a tertiary LLM performs safety and completeness checks; results are combined using a weighted voting system; and failed verifications trigger automatic regeneration with adjusted parameters.

The verification system implements specific checks including, by way of illustration and not limitation: step sequence validation against known constraints; resource availability verification against resource identified in a facility database; safety protocol compliance verification against regulatory requirements; cross-reference validation against established protocols; and temporal dependency(ies) verification between steps.

A fifth innovation of the disclosed subject matter addresses the development of a comprehensive world considerations model that dynamically tracks and responds to, for example, an operator's skill level and experience, laboratory environment specifications, available equipment and reagents, safety requirements and biosafety levels, facility-specific protocols and standards, and resource sharing constraints and scheduling. Indeed, the disclosed subject matter enables automatic, dynamic, protocol adaptation based on real-world constraints and conditions, while maintaining procedural accuracy.

The advantages of the new protocol format are obvious. Simply put, the disclosed system and protocol format provide effectual procedural guidance to an operator as the AR system understands the work environment and the work task. Indeed, AR-ization of protocols is extremely beneficial, providing the ability to alter protocols in small ways, and providing a variety of different ways for the AR system to generate and deliver AR-ized protocols and to tailor the information about protocols the system provides to in response to the skill, knowledge, explicit preferences, and queries of the operator.

Further, the disclosed system includes advantages extending beyond basic protocol conversion. The integrated protocol generation workflow provides substantial benefits through, by way of illustration and not limitation: (a) automated protocol optimization that incorporates relevant historical protocols through keyword extraction, adapts to available laboratory resources in real-time, maintains procedural accuracy while allowing modifications, and supports both individual and bulk protocol conversions; (b) robust verification mechanisms that employ robust recursive prompt verification techniques with reasoning to validate procedural steps, automatically regenerate protocols until verification criteria are met, and provide concrete metadata for safety and resource requirements; (c) dynamic world consideration integration that automatically adjusts protocols based on operator skill level, incorporates laboratory-specific equipment and reagent availability, ensures compliance with facility safety standards, optimizes shared resource utilization, and provides structured audit trails for regulatory compliance; (d) interactive protocol refinement capabilities that enable real-time protocol modifications with verification, support both automated and user-guided changes, maintain protocol integrity during alterations, and generate English-readable formats for review; and (e) smart environmental adaptation through automated questioning for missing contextual information, dynamic updates to world consideration database, proactive identification of safety requirements, and integration with laboratory management systems

The integrated verification system provides several critical advantages, including by way of illustration and not limitation, reduced protocol errors through automated verification, enables confident protocol modification while maintaining accuracy, supports regulatory compliance through systematic safety checks, and provides audit trail of protocol modifications and verifications.

Additionally, the world considerations model delivers additional benefits including, without limitation, automated adaptation to facility constraints, dynamic adjustment to operator skill progression, proactive safety requirement enforcement, optimal resource utilization through equipment and/or reagent tracking, and reduced training overhead through personalized guidance.

### The Context of AI Generation of AR Protocols

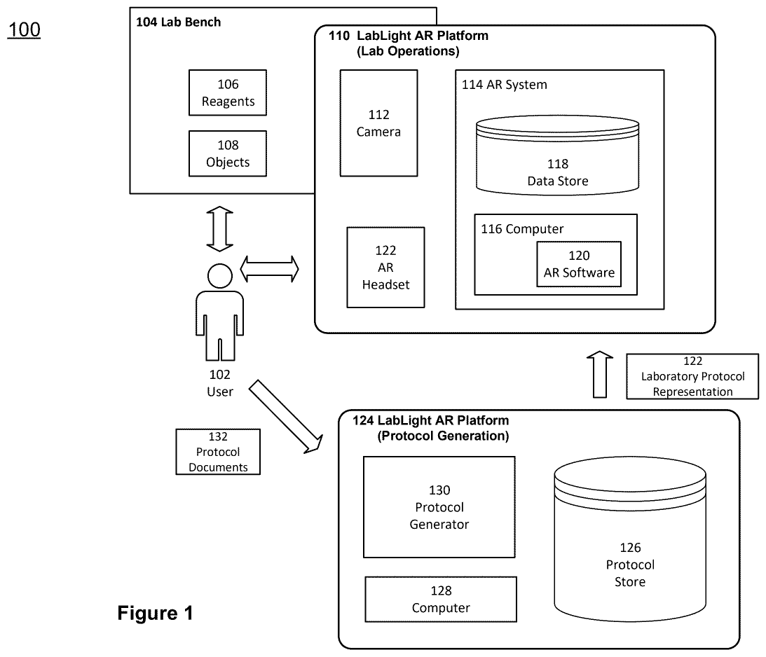

We now turn to FIG. 1, a context diagram 100 for AI generation of AR protocols.

User 102 is a lab worker that works on Lab Bench 104. User 102 generally is anyone who works with chemical and biological materials, collectively known as Reagents 106, by hand, including academic, life science manufacturing, and medical contexts. Reagents 106 may be any substance used for chemical or biological reactions including the chemicals used as feedstock for reactions, to catalysts and indicators (such as litmus paper and phenolphthalein). User 102 manipulates Reagents 106 with Objects 108. Object 108 is any lab equipment. In chemical and biological work, this may include equipment ranging from traditional chemistry set glassware such as flasks, graduated cylinders, and beakers, to automated and robotic machines.

The LabLight AR Platform (LLAR Platform) 110 is an augmented reality (AR) computer platform (the term AR broadly including mixed reality (MR) an extended reality (XR)). The LLAR System 110 in operational mode includes one or more video Cameras 112 that are directed to capture any activity performed on Lab Bench 104 or by User 102 in the context of chemical and biological lab bench activity. Video Cameras 112 may be any video camera that can interface with a computer such as via universal serial bus (USB), with sufficient resolution and frame speed for object recognition of objects in motion.

AR Headset 122 is an output device that provides video and audio to User's 102 sensorium. Examples include the Microsoft Hololens® and Apple's Vision Pro®.

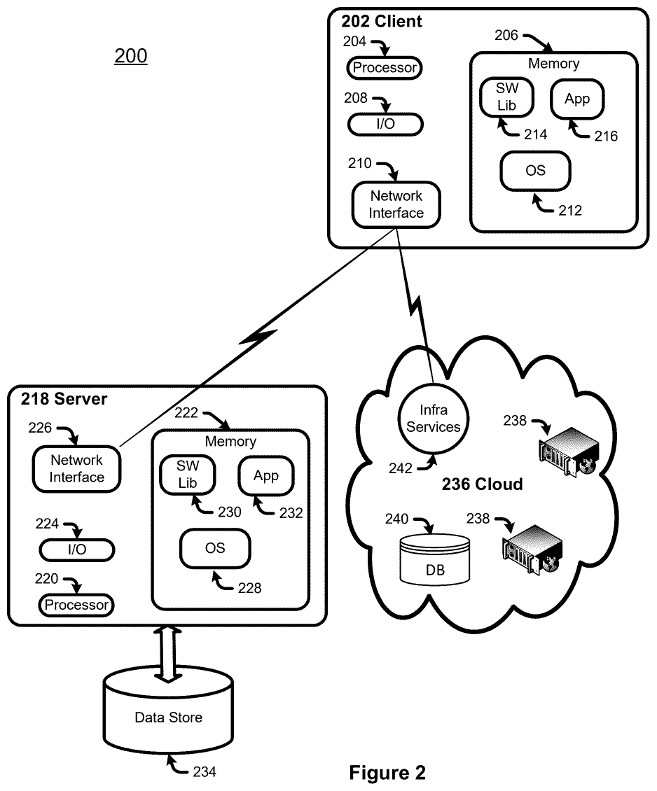

AR System 114 uses video Cameras 112 for input and AR Headset 122 for output. AR System 114 includes Computer 116 which works with Data Store 118 to execute computer executable instructions comprising the AR Software 120. AR Software 120 performs object recognition of Reagents 106, Objects 108, and activity by User 102, interprets the activity and generates virtual objects and audio output to User 102. Functional descriptions for Computer 116 and Data Store 118 are provided with respect to FIG. 2 below.

AR Software 120 makes use of a Laboratory Protocol Representation 122. A Laboratory Protocol Representation 122 is a protocol that describes a laboratory protocol, including its constituent steps, and for each step describes the respective Reagents 106 and Objects 108 involved, and the lab procedures and operations. Additionally, the Laboratory Protocol Representation 122 includes supplementary information that the LLAR Platform 110 is to surface in order to provide situational awareness, information that informs the LLAR Platform 110 as to what virtual objects and virtual object behaviors to render, and any information in general that the LLAR Platform 110 may render to provide assistance to User 102.

Laboratory Protocol Representation 122 is human readable and accordingly is generally formatted as text. Organization of data within a Laboratory Protocol Representation may be in a human readable format such as JavaScript Object Notation (JSON) or dialects of Extensible Markup Language (XML). Laboratory Protocol Representation 122 is a standardized format for an augmented reality computer platform in the sense that not only is it formatted to be human readable and the data organized, but also in the sense that it contains data fields and values for situational awareness, virtual objects, or procedural assistance information. Note that in some cases, the information includes references to external data, such as audio or video resources.

Laboratory Protocol Representation 122 originates from the LLAR Platform 124 in protocol generation mode. LLAR Platform 124 has a Protocol Store 126 which is a data store that stores pre-generated Laboratory Protocol Representations 122. Generation of Laboratory Protocol Representations 122 are via Computer 128 executing a Protocol Generator 130 software module. Computer 128 is described in further detail with respect to FIG. 2.

Protocol Generator 130 makes use of artificial intelligence (AI) and in particular Generative Artificial Intelligence (GenAI) techniques. Accordingly, Protocol Generator 130 makes use of one or more GenAI applications comprised of a GenAI Prompt Interface, a Context Buffer, a Retrieval Augmented Generation (RAG) buffer, a Reinforcement Learning (RL) Model, a Language Model, and adapters to interface the Reinforcement Learning Model (RL) to the Language Model. Language Model is a neural network trained on a large language data corpus such as ChatGPT or Claude, or alternatively a data corpus focused on medical data such as PubMed BERT. Since the Language Model is more focused on language, RL Model is another neural net trained on the subject matter for the GenAI application itself. RL Model is interfaced to the Language Model via adapters, which themselves are mini-neural networks to allow data transformation between the RL Model and the Language Model.

Operation of the GenAI application involves a GenAI Prompt interface receiving queries called prompts, and modifying the received prompts based on data in the Context Buffer which stores previous queries and based on data in the RAG buffer which contains supplementary documents uploaded by a user to provide additional context. The Prompt Interface tokenizes the modified prompt and submits it to the RL Model/Adapter/Language Model combination which in turn returns a tokenized response to the Prompt Interface. The Prompt Interface translates the tokenized response into a natural language for presentation.

Protocol Generator 130 receives one or more Protocol Documents 132 comprising electronic documents containing information about one or more laboratory protocols. Protocol Generator 130 makes use of specialized GenAI applications to interpret the received Protocol Documents 132 to convert into a Laboratory Protocol Representation 122. Note that because one or more GenAI applications are utilized, the Protocol Documents are never converted into an intermediate pseudocode. The Protocol Generator 130, upon creating Laboratory Protocol Representation 122, stores the Laboratory Protocol Representation 122 in Protocol Store 126.

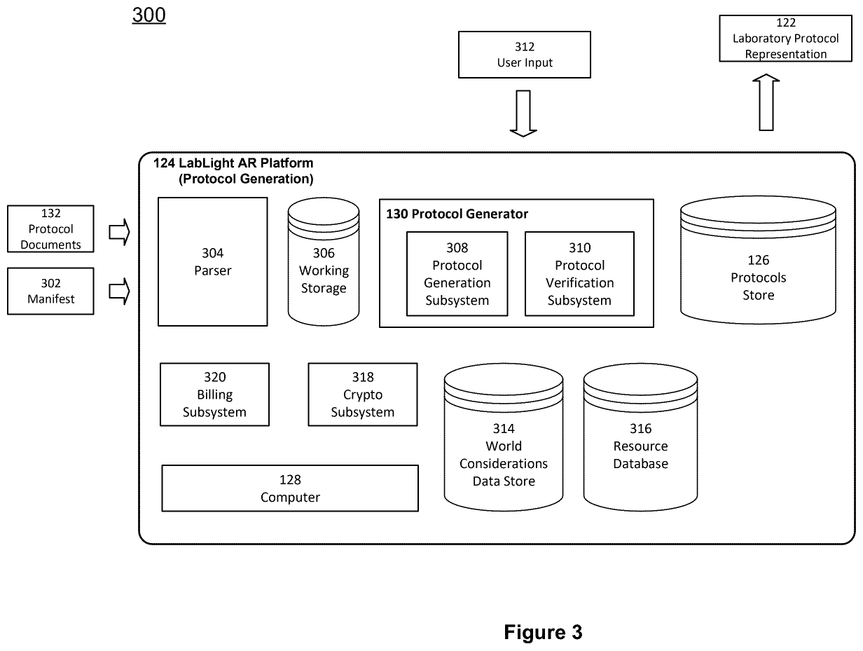

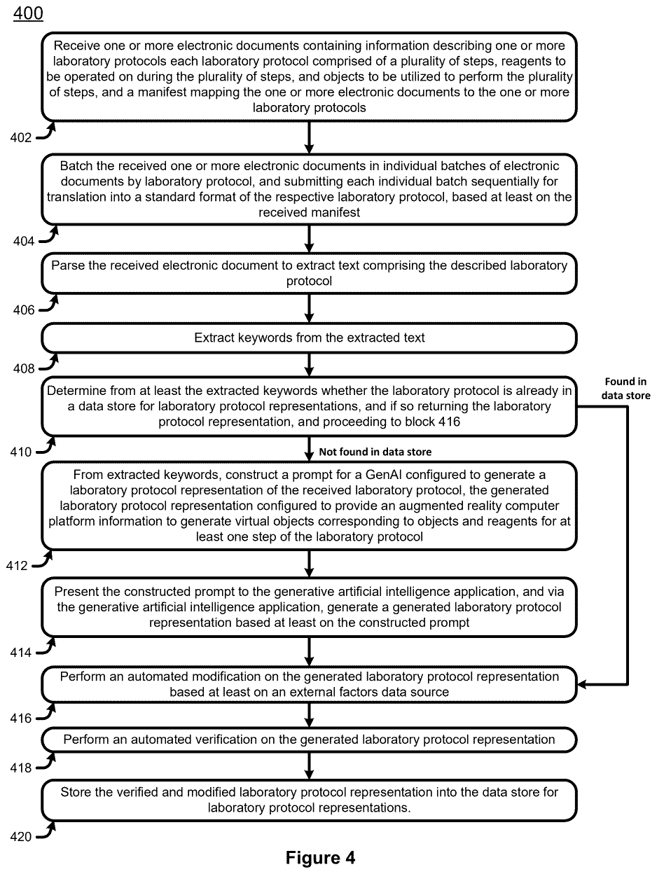

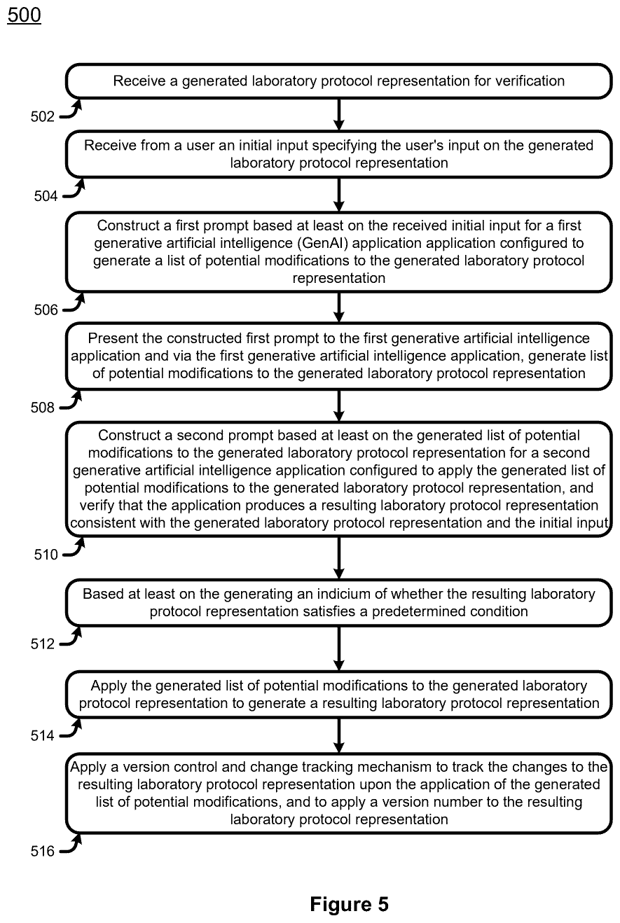

The internals of Protocol Generator 130 are described in further detail with respect to FIG. 3. The operation of Protocol Generator 130 is described in further detail with respect to FIGS. 4 and 5.

### Exemplary Environment for AI Generation of AR Protocols

Before describing AI Generation of AR Protocols in more detail, we describe in FIG. 2 an environment diagram 200 of an exemplary hardware, software, and communications computing environment.

### Client Platforms

The functionality for AI Generation of AR Protocols is generally hosted on a computing device. Exemplary computing devices include without limitation personal computers, laptops, embedded devices, tablet computers, smart phones, and virtual machines. In many cases, computing devices are to be networked.

One computing device may be a client computing device 202. The client computing device 202 may have a processor 204 and a memory 206. The processor may be a central processing unit, a repurposed graphical processing unit, and/or a dedicated controller such as a microcontroller. The client computing device 202 may further include an input/output (I/O) interface 208, and/or a network interface 210. The I/O interface 208 may be any controller card, such as a universal asynchronous receiver/transmitter (UART) used in conjunction with a standard I/O interface protocol such as RS-232 and/or Universal Serial Bus (USB). The network interface 210 may potentially work in concert with the I/O interface 208 and may be a network interface card supporting Ethernet and/or Wi-Fi and/or any number of other physical and/or datalink protocols.

Memory 206 is any computer-readable media which may store software components including an operating system 212, software libraries 214, and/or software applications 216. In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes at least two types of computer-readable media, namely computer storage media and communications media (e.g., carrier waves and transmission signals). Computer storage media includes volatile and non-volatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. For purposes of the disclosed subject matter, computer storage media expressly excludes communication media.

### Server Platforms

A server 218 is any computing device that may participate in a network. The network may be, without limitation, a local area network (“LAN”), a virtual private network (“VPN”), a cellular network, or the Internet. The server 218 is similar to the host computer for the image capture function. Specifically, it will include a processor 220, a memory 222, an input/output interface 224, and/or a network interface 228. In the memory will be an operating system 228, software libraries 230, and server-side applications 232. Server-side applications include file servers and databases including relational databases. Accordingly, server 218 may have a data store 234 comprising one or more hard drives or other persistent storage devices.

### Cloud Service Platforms

A service on cloud 236 may provide the services of a server 218. In general, servers may either be a physical dedicated server or may be embodied in a virtual machine. In the latter case, cloud 236 may represent a plurality of disaggregated servers which provide virtual application server 238 functionality and virtual storage/database 240 functionality. The disaggregated servers are physical computer servers, which may have a processor, a memory, an I/O interface and/or a network interface. The features and variations of the processor, the memory, the I/O interface and the network interface are substantially similar to those described for server 218. Differences may be where the disaggregated servers are optimized for throughput and/or for disaggregation.

Cloud 236 services 238 and 240 may be made accessible via an integrated cloud infrastructure 242. Cloud infrastructure 242 not only provides access to cloud services 238 and 240 but also to billing services and other monetization services. Cloud infrastructure 242 may provide additional service abstractions such as Platform as a Service (“PAAS”), Infrastructure as a Service (“IAAS”), and Software as a Service (“SAAS”).

As stated above, cloud 236 services generally disaggregate physical servers and reaggregate them into virtual machines. This process is accomplished via a software component called a hypervisor. Virtual machines appear to be like a physical server, but because of the disaggregation and reaggregation process, hypervisors enable the efficient use of hardware, as the virtual machine includes only the compute, store, and automation hardware requested, leaving excess hardware capacity to be used in other virtual machines.

Because virtual machines behave like physical servers, the time to boot up the virtual machine may take an unacceptable amount of time. To this end, containerization software such as Google Kubernetes (TM) and Docker, enable partitions of the virtual machine (called containers), to perform compute functions on demand without boot time delay.

### Exemplary System for AI Generation of AR Protocols

We are now ready to describe the LLAR Platform 124 itself. LLAR Platform 124 includes Computer 128 and includes a plurality of software modules to execute on Computer 128 as described herein. In some embodiments, LLAR Platform 124 is comprised of hardware that operates in the same local area network and therefore need not be networked to the Internet or outside world to operate. In some embodiments, the LLAR Platform 124 may run self-contained on a single computer such as a laptop.

LLAR Platform 124 in protocol generation mode receives one or more Protocol Documents 132, and optionally a Manifest 302 as input. As described above, Protocol Documents 132 are electronic documents that describe a laboratory protocol. Because LLAR Platform 124 makes use of GenAI which can receive unstructured and semi-structured data, a protocol may be described by a plurality of Protocol Documents 132.

Additionally, User 102 may wish to input multiple protocols for translation into their own respective Laboratory Protocol Representation 122. Manifest 302 provides a mapping of the multiple Protocol Documents 132 to the multiple laboratory protocols to be represented. The Manifest 132 thereby provides hints to any receiving GenAI applications in LLAR Platform 124 as to which inputs relate to which laboratory protocols. Generally Manifest 302 is a human readable text file and need not have a specific format. In some embodiments, Manifest 302 may be a text file transcription of handwritten notes.

Protocol Documents 132 and Manifest 302 are received by Parser 304. Parser 304 is a software module configured to translate known computer file formats such as Adobe Acrobat's® PDF and Microsoft Word's® DOCX formats into text. Translated text is then stored in Working Storage 306 in computer memory. In some embodiments, Working Storage 306 may be a relational database.

Protocol Generator 130 operates on Working Storage 306 with one or more specialized GenAI applications to read Working Storage 306 and to generate a Laboratory Protocol Representation 122 via Protocol Generation Subsystem 308. The Laboratory Protocol Representation 12 is then verified with the assistance of one or more GenAI applications in Protocol Verification Subsystem 310.

Protocol Generator 130 makes use of additional information beyond Protocol Documents 132 and Manifest 302. Specifically, Protocol Generator 130 may make use of User Input 312, environmental and user data such as stored in World Considerations Data Store 314 and rules in Resource Database 316. Resource Database 316 is a rules engine that contains rules that one or more laboratory protocols are to observe and under what conditions. In some embodiments, other Laboratory Protocol Representations stored in the Protocols Store 126 may be references and cross referenced. In this way any constituent GenAI applications will have access to all relevant information in the generation and validation of a generated Laboratory Protocol Representation 322.

The Protocol Generation Subsystem 308 makes use of User Input 312 in the form of text data describing how a User 102 may wish to customize a laboratory protocol. Examples include: (a) volume scaling—the modification of the amounts of Reagents 106 and the Objects 108 to be utilized based on changes in the volume of material to be produced, (b) step sequence reorganization—the modification of the order of steps to use based on world considerations such as the layout of the Lab Bench 104 and/or laboratory itself, (c) equipment substitution—changes in procedures from using equivalent but different makes and models of equipment, or in using functionally equivalent but different equipment, based on what equipment is available, and (d) adjustment of wait times—changes in the amount of time for procedural pauses based on the needs of User 102.

Because the Protocol Generation Subsystem 308 and Protocol Validation Subsystem 310 make use of GenAI applications, the risk of the generation of false output, called hallucinations, is to be mitigated. Protocol Validation Subsystem 310 may make use of hallucination detection methodologies including Chain-of-Thought (CoT) recursive Chain-of-Thought (rCoT) reasoning and Contrastive Verification (CoVe) techniques. In such embodiments, the Protocol Generation Subsystem 308 and the Protocol Validation Subsystem 310 may iterate to make additional modifications until the generated Laboratory Protocol Representation 122 meets or exceeds a predetermined condition. If the predetermined condition is met or exceeded, the iteration stops, and the final Laboratory Protocol Representation 122 is considered complete and may be stored in Protocols Store 126.

In embodiments where each iteration involves User Input 312, we note that the Protocol Verification Subsystem 310 may make use of a software dialog system in which to query a User 102 and receive User Input 312. In this way, “human in the loop” techniques may be applied.

The operation of the Protocol Generator 130 is described in greater detail with respect to FIGS. 4 and 5.

In some embodiments, the LLAR Platform 124 may wish to charge for use. In particular, GenAI applications in the Protocol Generator 130 may make use of third-party Language Models which charge for use. Many present Language Models charge for use on a per token processing basis. In order to make payment, the LLAR Platform 124 includes a Crypto Subsystem 318 which enables the tracking of Users 102 and their identities and authorized computer privileges, and a Billing Subsystem 320 to provide payment.

### Exemplary Process for AI Generation of AR Protocols

We are now ready to describe the operation of the LLAR Platform 124. FIG. 4 is a flow chart 400 describing the generation of a Laboratory Protocol Representation 122 that can be used by the LLAR Platform 110 in lab operations mode.

Turning to FIG. 4, in block 402, the LLAR Platform 124 receives one or more Protocol Documents 132 and optionally a Manifest 302. The LLAR Platform 124 generally receives electronic documents via Parser 304. Parser 304 will generally queue the files into a buffer for organization and processing prior to performing actual parsing operations. In block 404, Parser 304 interprets Manifest 302, and then batches the received Protocol Documents 302 according to the laboratory protocol to be represented. In this way, Parser 304 may optionally send electronic document batches for processing sequentially such that only one Laboratory Protocol Representation 122 is processed at a time. In other embodiments, Parser 304 may make use of a GenAI application and perform the processing of the batches in parallel.

In block 406, Parser 304 converts the electronic document into a text format using a decoding library. Decoding libraries are generally available for file conversion of commonly used document formats such as Adobe Acrobat's® PDF and Microsoft Word's® DOCX. The extracted text is then stored in Working Storage 306.

In block 408, the Protocol Generation Subsystem 308 accesses the Working Storage 306 to interpret the extracted text. As a preliminary step, the Protocol Generation Subsystem 308 scans the text to select keywords from the extracted text. Selection may be performed via a GenAI application. In block 410, the Protocol Generation Subsystem 308 uses the selected keywords to query the Protocols Store 126 for the same laboratory protocol. If the laboratory protocol is found, an initial version of the laboratory protocol representation 122 need not be generated, and processing proceeds to block 416 for customization.

If the laboratory protocol is not found in Protocols Store 126, processing proceeds to block 412. Note that Protocol Generation Subsystem 308 may implement a GenAI application configured to generate a Laboratory Protocol Representation for the laboratory protocol described in Protocol Documents 132. In block 412, the GenAI application Protocol Generation Subsystem 308 constructs a prompt for the GenAI application based at least on the extracted keywords. In practice, the Protocol Generation Subsystem 308 will make use of additional input information including User Input 312 and other Laboratory Protocol Representations 122 in Protocols Store 126, and rules in Resource Database 316.

In block 414, the constructed prompt is sent to the GenAI application which generates Laboratory Protocol Representation 122 for the laboratory protocol in the batch of electronic documents from the received Protocol Documents 132.

In block 416, the Laboratory Protocol Representation 122 is modified at least on an external factors data source such as World Considerations Data Store 314. The World Considerations Data Store 314 may store information about User 102, such as ratings and certifications. For example, if a User 102 is not rated or certified for certain procedures, Protocol Generation Subsystem 308 may modify the Laboratory Protocol Representation 122 to have substitute procedures that the User 102 is rated for. The World Considerations Data Store 314 may store inventory information about available reagents. If the World Considerations Data Store indicates that a particular Reagent 106 is not available, the Protocol Generation Subsystem 308 may modify the Laboratory Protocol Representation 122 to use a substitute.

In the event in block 410 a Laboratory Protocol Representation 122 was identified, in block 416 Laboratory Protocol Representation 122 may also be modified via user customizations as per User Input 312.

In block 418, Protocol Verification Subsystem 310 performs a verification of the generated Laboratory Protocol Representation 122. In practice, Protocol Verification Subsystem 310 makes use of iterative techniques. Accordingly, Protocol Generation Subsystem 308 will make candidate Laboratory Protocol Representations 122, and Protocol Verification Subsystem 310 will generate candidate recommendations to modify Laboratory Protocol Representation 122, the two Subsystems 308, 310 iterating until a predetermined condition is satisfied. For example, Protocol Validation Subsystem 310 may generate a score for Laboratory Protocol Representation 322 such as a statistical confidence score, where iteration stops upon the score being met or exceeded. Validation is described in further detail with respect to FIG. 5.

In block 420, upon the predetermined condition being satisfied, the final resulting Laboratory Protocol Representation 322 is stored in Protocols Store 126. The stored final resulting Laboratory Protocol Representation 322 may then be retrieved from Protocols Store 126 by LLAR Platform 110 in operations mode, for use by User 102.

### Exemplary Process for Validating AI Generated AR Protocols

Turning to FIG. 5, flow chart 500 describes the verification process of a generated Laboratory Protocol Representation 122.

In block 502, Protocol Verification Subsystem 310 receives a Laboratory Protocol Representation 122 that has just been generated by Protocol Generation Subsystem 308. Protocol Verification Subsystem 310 is to perform operations to verify Laboratory Protocol Representation 122 prior to being released for use.

Recall that Protocol Generation Subsystem 308 does not merely translate existing laboratory protocols into a standardized format for an augmented reality computer platform but also customizes the laboratory protocol based on User Input 312. Accordingly, in block 504, Protocol Verification Subsystem 310 receives an initial input comprising User Input 312 specifying User 102 preferences. In this way, Protocol Verification Subsystem 310 can verify whether those preferences were met by Laboratory Protocol Representation 122 as part of the overall verification process.

Protocol Validation Subsystem 310 may make use of two GenAI applications used in concert. The first GenAI application is responsible for generating a list of potential modifications to Laboratory Protocol Representation 122. These potential modifications are candidate changes to the Laboratory Protocol Representation 122 to correct errors and invalid conditions detected. The second GenAI application is responsible for determining whether the application of those potential modifications to the Laboratory Protocol Representation 122 creates a resulting Laboratory Protocol Representation 122 consistent with the laboratory protocol being modeled and User Input 312. In practice, the Protocol Validation Subsystem 310 will also make use of external factors such as in the World Considerations Data Store 314, rules in Resource Database 316, and correlations with other Laboratory Protocol Representations in Protocols Store 126.

In block 506, the Protocol Validation Subsystem 310 constructs a prompt for the first GenAI app to generate a list of potential modifications. In block 508, the constructed prompt is then presented to the first GenAI app which then generates the list of potential modifications.

In block 510, the Protocol Validation Subsystem 310 constructs a prompt for the second GenAI app to determine whether the potential modifications are consistent with the laboratory protocol and other inputs as described above.

In block 512, the second GenAI application generates an indicium such as a score to compare with a predetermined condition. If the predetermined condition is satisfied, the potential list of modifications is sent to the Protocol Generation Subsystem 308, which in block 514 applies the list of modifications which generates a resulting Laboratory Protocol Representation 122.

In block 516 the resulting Laboratory Protocol Representation 122 can then be stored in Protocols Store 126 for access by User 102. Note that a laboratory protocol will have multiple Laboratory Protocol Representations 122 stored in Protocols Store 126. This is a result of the customization process. Accordingly, the LLAR Platform 124 includes a version control and change tracking mechanism to assign a unique version number to the resulting Laboratory Protocol Representations 122 and to document modifications made. In this way, a User 102 can distinguish between customizations, and select the most appropriate Laboratory Protocol Representation 122 as needed.

### Use Cases

Generally speaking, the disclosed subject matter allows procedures and setup to be adaptable to operators'skill and experience, enabling quick onboarding and continued usage of AR throughout skill progression. Indeed, the disclosed systems have broad commercial applications across numerous operational fields, such as but without limitation: (a) Research laboratories, providing rapid protocol deployment and modification, automated safety compliance, efficient resource management, and streamlined training programs; (b) Biomanufacturing facilities, providing standardized procedure implementation, real-time protocol adaptation, quality control enhancement, and regulatory compliance support; (c) Clinical laboratories, providing protocol consistency assurance, skill-based workflow optimization, equipment utilization tracking, and safety protocol enforcement; and (d) Educational Institutions, providing adaptive learning environments, hands-on laboratory training, safety protocol instruction, and resource scheduling optimization.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method to convert a textual description of a laboratory protocol into a standardized format for an augmented reality computer platform, comprising:
receiving an electronic document containing information describing a laboratory protocol comprised of a plurality of steps, reagents to be operated on during the plurality of steps, and objects to be utilized to perform the plurality of steps;
parsing the received electronic document to extract text comprising the described laboratory protocol;
extracting keywords from the extracted text;
constructing a prompt based at least on the extracted keywords, for a generative artificial intelligence (GenAI) application configured to generate a laboratory protocol representation of the laboratory protocol, the laboratory protocol representation formatted in a standardized format configured to provide an augmented reality computer platform information to generate virtual objects corresponding to objects and reagents for at least one step of the laboratory protocol;
presenting the constructed prompt to the generative artificial intelligence application, and via the generative artificial intelligence application, generate a generated laboratory protocol representation based at least on the constructed prompt;
performing an automated modification on the generated laboratory protocol representation based at least on an external factors data source;
performing an automated verification on the generated laboratory protocol representation; and
storing the verified and modified laboratory protocol representation into a data store for laboratory protocol representations.

2. The method of claim 1, wherein the standard format includes situational awareness indicia metadata for at least one step.

3. The method of claim 1, wherein the standard format is human intelligible, and the generation did not include use of an interim pseudocode.

4. The method of claim 1, wherein the verification on the generated laboratory protocol representation is via a hallucination detection methodology.

5. The method of claim 4, wherein the hallucination detection methodology is performed by a secondary LLM.

6. The method of claim 4, wherein the hallucination detection methodology is Chain of Thought (COT).

7. The method of claim 4, comprising receiving an initial input, and wherein the hallucination detection methodology includes recursing until the hallucination detection methodology satisfies a predetermined threshold based on the received initial input.

8. The method of claim 1, comprising:
receiving in addition an electronic document containing information describing a laboratory protocol, one or more additional electronic documents containing information describing either the laboratory protocol or additional laboratory protocols;
receiving a manifest describing a mapping of the received electronic documents to the laboratory protocols described; and
batching electronic documents to be translated into a standard format, by individual laboratory protocols based at least on the received manifest.

9. The method of claim 1, wherein the augmented reality computer platform is a platform configured to detect spatial location, orientation, and attitude of objects and reagents described in the laboratory protocol and the generated corresponding virtual objects reflect the detected spatial location, orientation, and attitude of the respective objects and reagents.

10. The method of claim 9, wherein the augmented reality computer platform makes use solely of computer hardware on the same local network.

11. A method to perform an automated verification on the generated laboratory protocol representation, comprising:
receiving a generated laboratory protocol representation for verification;
receiving from a user an initial input specifying the user's input on the generated laboratory protocol representation;
constructing a first prompt based at least on the received initial input for a first generative artificial intelligence (GenAI) application configured to generate a list of potential modifications to the generated laboratory protocol representation;
presenting the constructed first prompt to the first generative artificial intelligence application and via the first generative artificial intelligence application, generate list of potential modifications to the generated laboratory protocol representation;
constructing a second prompt based at least on the generated list of potential modifications to the generated laboratory protocol representation for a second generative artificial intelligence application configured to apply the generated list of potential modifications to the generated laboratory protocol representation, and verify that the application produces a resulting laboratory protocol representation consistent with the generated laboratory protocol representation and the initial input;
presenting the constructed second prompt to the second generative artificial intelligence application and via the second generative artificial intelligence determine whether the generated list of potential modifications when applied to the generated laboratory protocol representation produces a resulting laboratory protocol representation consistent with the generated laboratory protocol representation and the initial input; and
based at least on the generating an indicium of whether the resulting laboratory protocol representation satisfies a predetermined condition.

12. The method of claim 11, comprising applying the generated list of potential modifications to the generated laboratory protocol representation, in order to generate a resulting laboratory protocol.

13. The method of claim 12, comprising applying a version control and change tracking mechanism to track the changes to the resulting laboratory protocol representation upon the application of the generated list of potential modifications, and to apply a version number to the resulting laboratory protocol representation.

14. The method of claim 11, wherein the determining whether the generated list of potential modifications when applied to the generated laboratory protocol representation produces a resulting laboratory protocol consistent representation with the generated laboratory protocol representation and the initial input is a hallucination detection methodology.

15. The method of claim 14, wherein the hallucination detection methodology is a recursive methodology.

16. The method of claim 15, wherein the recursive methodology, is any one of recursive Chain-of-Thought (rCoT) or Contrastive Verification (CoVe).

17. The method of claim 11, wherein the initial input comprises any one or more of volume scaling, step sequence reorganization, equipment substitution, and adjustment of wait time.

18. The method of claim 11, comprising receiving input from a resource database, wherein the verification that the application produces a resulting laboratory protocol representation consistent with the generated laboratory protocol representation and the initial input is based at least on the received input from a resource database.

19. The method of claim 11, comprising receiving input from a world considerations model, wherein the generating list of potential modifications to the generated laboratory protocol is based at least on the received input from the world considerations model.

20. A system to convert a textual description of a laboratory protocol into a standardized format for an augmented reality computer platform, comprising:
a computer processor configured to execute computer executable instructions,
communicatively coupled to a computer readable memory, the computer readable memory storing computer executable instructions configured to:
receive an electronic document containing information describing a laboratory protocol comprised of a plurality of steps, reagents to be operated on during the plurality of steps, and objects to be utilized to perform the plurality of steps;
parse the received electronic document to extract text comprising the described laboratory protocol;
extract keywords from the extracted text;
construct a prompt based at least on the extracted keywords, for a generative artificial intelligence (GenAI) application configured to generate a laboratory protocol representation of the laboratory protocol, the laboratory protocol representation formatted in a standardized format configured to provide an augmented reality computer platform information to generate virtual objects corresponding to objects and reagents for at least one step of the laboratory protocol;
present the constructed prompt to the generative artificial intelligence application, and via the generative artificial intelligence application, generate a generated laboratory protocol representation based at least on the constructed prompt;
perform an automated verification on the generated laboratory protocol representation;
perform an automated modification on the generated laboratory protocol representation based at least on an external factors data source; and
store the verified and modified laboratory protocol representation into a data store for laboratory protocol representations.
